(19) United States
(12) Patent Application Publication
(10) Pub. No.: US 2020/0176135 A1
(43) Pub. Date: Jun. 4, 2020

(54) LOW TEMPERATURE CONTROLLABLE NUCLEAR FUSION DEVICE AND REALIZATION MODE THEREOF

(71) Applicant: Shihao Chen, Changchun (CN)

(72) Inventors: Shihao Chen, Changchun (CN); Ziwei Chen, Changchun (CN); Yunpeng Jiang, Changchun (CN); Qiangong Chen, Changchun (CN); Jiacheng Gao, Changchun (CN)

(73) Assignee: Shihao Chen

(21) Appl. No.: 16/741,773

(22) Filed: Jan. 14, 2020

(30) Foreign Application Priority Data
Jul. 29, 2019 (CN) 201910731956.1

(51) Int. Cl. G21B 3/00; G21B 1/21; G21B 1/05

(52) U.S. Cl. CPC G21B 3/006; G21B 1/05; G21B 1/21

(57) ABSTRACT

The present invention discloses a low temperature controllable nuclear fusion device and a realization method thereof. The nuclear fusion device comprises a neutron source, an energy transmission system and a shielding layer. Neutrons radiated by the neutron source are used to irradiate the target nucleus-containing substance; the target nucleus of the neutron absorption is fissioned into a plurality of sub-nuclei; the released energy is transmitted by the energy transmission system; and the residual neutrons not absorbed by the target nucleus are completely absorbed by the shielding layer. The sub-nuclei and electrons produced by fission are finally combined into atoms and energy is released. The overall process of the present invention can be realized at low temperature, is easy to control, has no problem with Lawson conditions, and produces no radioactive spent nuclear fuel.

### TECHNICAL FIELD

The present invention belongs to the technical field of nuclear fusion and particularly relates to a low temperature controllable nuclear fusion device and a realization method thereof.

### BACKGROUND

Controllable nuclear fusion not only requires high temperature of more than 100 million degrees Celsius, but also need to meet the Lawson conditions. For a plasma with high temperature of 100 million degrees Celsius, the Lawson conditions are difficult to satisfy. The root cause is that a strong electrostatic repulsion potential exists between bare atomic nuclei with positive charges. In view of this, neutrons are considered to achieve nuclear fusion. The disadvantage of the nuclear fusion relative to traditional designed nuclear fusion is that the nuclear fusion releases less energy and energy density. Moreover, a lot of energy is consumed in the process of producing neutron beams. The heat energy produced in this process needs to be effectively recycled to ensure that the output energy in the overall process of the nuclear fusion is larger than input energy, thereby ensuring that the nuclear fusion manner is meaningful.

Therefore, the problem to be urgently solved by those skilled in the art is how to provide a low temperature controllable nuclear fusion device with output energy greater than input energy and a realization method thereof.

### SUMMARY

In view of this, the present invention provides a low temperature controllable nuclear fusion device and a realization method thereof. The overall process can be realized at low temperature, is easy to control, has no problem with Lawson conditions, and produces no radioactive spent nuclear fuel.

To achieve the above purpose, the present invention adopts the following technical solution:

A low temperature controllable nuclear fusion device comprises a neutron source, an energy transmission system and a shielding layer, wherein neutrons radiated by the neutron source are used to irradiate the target nucleus-containing substance; the energy of the neutrons is adjusted according to a selected target nucleus; the target nucleus of the neutron absorption is fissioned into a plurality of sub-nuclei; at the same time, energy is released; the released energy is transmitted by the energy transmission system; the residual neutrons not absorbed by the target nucleus are completely absorbed by the shielding layer; and the sub-nuclei and electrons produced by fission are finally combined into atoms and energy is released.

Preferably, the low temperature controllable nuclear fusion device further comprises a target nucleus-containing substance conveying system which keeps the target nucleus-containing substance in updating the flow; the target nucleus after neutron absorption are fissioned into a plurality of sub-nuclei; due to thermal motion and interaction, the target nucleus-containing substance becomes a plasma composed of positive and negative ions, electrons and unionized atoms; in addition to directly utilizing the heat energy of the plasma, the energy of the plasma is also used through a magnetohydrodynamic power generation technology; the plasma flows through a strong magnetic field with strength greater, than 1 Tesla at high speed, positive, and negative charged particles move in opposite directions to form positive and negative electrodes to generate electromotive force; and neutral target nucleus particles and other target nucleus-containing substance are conveyed back to a neutron radiation region.

A realization method of low temperature controllable nuclear fusion is realized based on the above nuclear fusion device; neutrons radiated by the neutron source are used to irradiate the target nucleus-containing substance; the energy of the neutrons is adjusted according to a selected target nucleus; the target nucleus of the neutron absorption is fissioned into a plurality of sub-nuclei; at the same time, energy is released; the released energy is transmitted by the energy transmission system; the residual neutrons not absorbed by the target nucleus are completely absorbed by the shielding layer; and the sub-nuclei and electrons produced by fission are finally combined into atoms and energy is released.

Preferably, the neutron source adopts an electron neutron source, a gamma photoneutron source, a spallation neutron source, a reactor neutron source or a spontaneous radiation neutron source.

Preferably, when the neutron source adopts the electron neutron source, in a vacuum chamber, a neutron-rich nucleus is dissociated into electrons and bare nuclei; the electrons and the bare nuclei are separated by an electric field and a magnetic field and are respectively modulated into single-energy electron beams and ion beams; the single-energy electron beams and the single-energy ion beams are respectively conveyed to a collision region by the magnetic field perpendicular to an electron and ion conveying pipeline; a strong magnetic field having an intensity more than 1 T and parallel to the electron beams and the bare, nuclei is arranged in the collision region; the electron beams and the ion beams of the bare nuclei conduct anti-parallel motion and collision; the kinetic energy of the electrons relative to the bare nuclei is greater than the binding energy of the last neutron of the bare nuclei; due to the electromagnetic and weak effects of quarks in the electrons and the nuclei, the naked nuclei are fragmented into a plurality of sub-nuclei after collision, and the neutron is one of the sub-nuclei; the generated neutrons are radiated into a fusion target nucleus region and conduct a fusion reaction with the target nucleus.

Preferably, when the neutron source adopts the gamma photoneutron source, the target atoms are directly irradiated with gamma laser or gamma rays having single-photon energy relative to the target nucleus greater than the binding energy of the target nucleus and the electrons, to dissociate the target nucleus into neutrons and other sub-nuclei; other sub-nuclei are separated for standby by the electric field and the magnetic field; and the neutrons are radiated to the target nucleus which conducts fusion with the neutrons to conduct a fusion reaction with the target nucleus, wherein the neutron-rich nuclei are irradiated with gamma laser or gamma rays by the gamma photoneutron source to produce single energy neutrons.

Preferably, when the neutron-rich nuclei adopt deuterium nuclei, the same number of protons are produced while generating the neutrons; when the protons and the electrons are combined into hydrogen atoms, photons with energy greater than 13.6 eV are emitted; the photons are used to irradiate the helium atoms; the deuterium atoms are dissociated into the deuterium nuclei and electrons; the electric field and the magnetic field are used to separate the deuterium nuclei from the electrons for standby.

Heat energy is also generated in the process of generating gamma light; the heat energy is generated in the process of irradiation of the deuterium nuclei with the gamma light to dissociate the deuterium nuclei into the protons and the neutrons and in the process of absorbing the neutrons by the shielding layer; and all the heat energy is transmitted by the energy transmission system and is used.

Preferably, when the neutron source adopts the spontaneous radiation neutron source, the atomic nucleus of the spontaneous radiation neutron source is unstable; one of decay products is a neutron; the energy and the quantity of the radiated neutrons are determined by the decaying, atomic nucleus; and the energy of the radiated neutrons is matched with the energy required for fusion, wherein part of the neutrons conduct a fusion reaction with the target nucleus.

The present invention has the following advantageous effects:

The overall process of the nuclear fusion of the present invention can be realized at low temperature, is easy to control, has no problem with Lawson conditions, and produces no radioactive spent nuclear fuel. The heat energy that is generated in the process of generating the neutrons can be effectively used. No proton polymerization occurs in the overall process and electrostatic repulsive potential energy between protons is not required to be overcome, thereby ensuring that the output energy in the overall process of the nuclear fusion is larger than input energy.

### BRIEF DESCRIPTION OF THE DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a structural principle diagram of a low temperature nuclear fusion device of the present invention.

In the FIGURE,

1—collision region of electrons and neutron-rich bare nuclei; 2—target atom region; 3—magnet; and 4—shielding layer.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

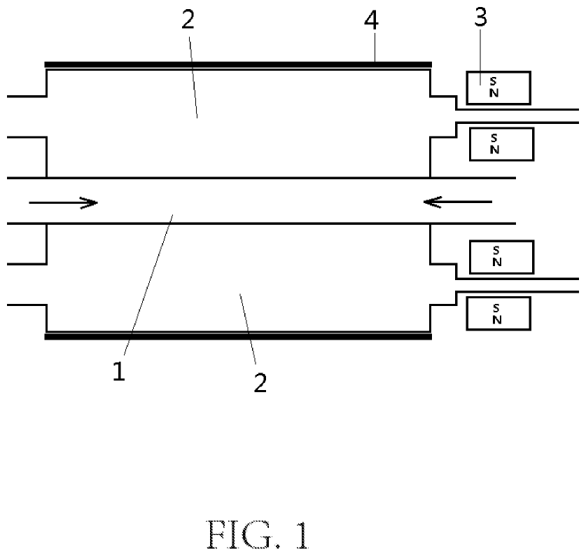

Referring to FIG. 1, the present invention provides a low temperature controllable nuclear fusion device which comprises a neutron source, an energy transmission system and a shielding layer 4, wherein neutrons radiated by the neutron source are used to irradiate the target nucleus-containing substance; the energy of the neutrons is adjusted according to a selected target nucleus; the target nucleus of the neutron absorption is fissioned into a plurality of sub-nuclei; at the same time, energy is released; the released energy is transmitted by the energy transmission system; the residual neutrons not absorbed by the target nucleus are completely absorbed by the shielding layer 4; and the sub-nuclei and electrons produced by fission are finally combined into atoms and energy is released.

The present invention further comprises a target nucleus-containing substance conveying system which keeps the target nucleus-containing substance in updating the flow; the target nucleus after neutron absorption are fissioned into a plurality of sub-nuclei; due to thermal motion and interaction, the target nucleus-containing substance becomes a plasma composed of positive and negative ions, electrons and unionized atoms; in addition to directly utilizing the heat energy of the plasma, the energy of the plasma is also used through a magnetohydrodynamic power generation technology; the plasma flows through a strong magnetic field, with strength greater than 1 Tesla at high speed; the strong magnetic field is generated by magnets 3 on both sides of an ion high-speed outflow channel; positive and negative charged particles move in opposite directions to form positive and negative electrodes to generate electromotive force; and neutral target nucleus particles and other target nucleus-containing substance are conveyed back to a neutron radiation region.

The present invention also provides a realization method of low temperature controllable nuclear fusion. The method is realized based on the above nuclear fusion device; neutrons radiated by the neutron source are used to irradiate the target nucleus-containing substance; the energy of the neutrons is adjusted according to a selected target nucleus; the target nucleus of the neutron absorption is fissioned into a plurality of sub-nuclei; at the same time, energy is released; the released energy is transmitted by the energy transmission system; the residual neutrons not absorbed by the target nucleus are completely absorbed by the shielding layer 4; and the sub-nuclei and electrons produced by fission are finally combined into atoms and energy is released.

The neutron source adopts an electron neutron source, a gamma photoneutron source, a spallation neutron source, a reactor neutron source or a spontaneous radiation neutron source.

The neutrons can react with all nuclei; thus, multiple options exist for the target nucleus herein, wherein two options are ⁶Li nucleus and ¹⁰B nucleus; the neutrons used are thermal neutrons; the fusion reactions as a basis are

n+⁶Li→α+³T+4.783 MeV, σ_{Li0}=936 b,

n+¹⁰B→α+⁷Li+2.792 MeV, σ_{B0}=3840 b,

In the formulas, σ_{Li0} and σ_{B0} are respectively reaction cross sections of the thermal neutrons and the ⁶Li nucleus and the ¹⁰B nucleus.

The essence of nuclear energy release is: one combination mode A of a certain number of nuclei has higher energy relative to another combination mode B. Therefore, when the combination mode of the nuclei is converted from A to B through a physical process, nuclear energy is released.

The total energy of one deuterium nucleus and one ⁶Li nucleus is

[(m_{d}+m_{Li})−(m_{α}+m_{T}+mₚ)]c²=[(2.014102+6.015123)−(4.002603+3.016050+1.007825)]×931.494=2.55881 MeVₒ

When energy 2.24 MeV is inputted to make d→p+n through the above physical process,

[(mₚ+mₙ+m_{Li})−(m_{α}+m_{T}+mₚ)]c²=[(0.007825+1.008665+6.015123)−(4.002603+3.016050+1.007825)]×931.494=4.78322 MeVₒ

In the process of generating the required thermal neutrons, consumed energy Eₙ is obviously greater than 2.224 MeV. Let ΔE=Eₙ−2.224. Then, if ΔE<2.55881 MeV, the nuclear fusion reaction releases energy. If ΔE≥2.55881 MeV, the nuclear fusion reaction does not release energy. ΔE generally exists in the form of heat energy, and a part can be effectively used. In this way, actual consumed energy is less than ΔE. It can be seen that it is possible to release nuclear energy in the nuclear fusion mode.

The nuclear fusion proposed herein has essential differences from the traditional designed nuclear fusion mode in that no proton polymerization occurs in the overall process and electrostatic repulsive potential energy between protons is not required to be overcome.

When the neutron source adopts the electron neutron source, in a vacuum chamber, a neutron-rich nucleus is dissociated into electrons and bare nuclei; the electrons and the bare nuclei are separated by an electric field and a magnetic field, and are respectively modulated into single-energy electron beams and ion beams; the single-energy electron beams and the single-energy ion beams are respectively conveyed to a collision region by the magnetic field perpendicular to an electron and ion conveying pipeline; a strong magnetic field having an intensity more than 1 T and parallel to the electron beams and the bare nuclei is arranged in the collision region; the electron beams and the ion, beams of the bare nuclei conduct anti-parallel motion and collision; the kinetic energy of the electrons relative to the bare nuclei is greater than the binding energy of the last neutron, of the bare nuclei; due to the electromagnetic and weak effects of quarks in the electrons and the nuclei, the naked nuclei are fragmented into a plurality of sub-nuclei after collision, and the neutron is one of the sub-nuclei; more than 99% of neutrons are neutrons of the original naked nuclei, and less than 1% of neutrons are converted from protons;

multiple options exist for the used neutron-rich nucleus, wherein two neutron-rich nuclei are deuterium nucleus d and beryllium nucleus ⁹Be; the electrons having the kinetic energy relative to the deuterium nucleus greater than the binding energy 2.224 MeV of the deuterium nucleus collide with the deuterium bare nucleus to generate the following reaction

e⁻+d→e⁻′+p+n−2.224 MeV,

the electrons having the kinetic energy relative to the beryllium nucleus ⁹Be greater than the binding energy 1.665 MeV of the beryllium nucleus ⁹Be collide with the ⁹Be nucleus to generate the following reaction

e⁻+⁹Be→e⁻′+⁸Be+n−1.665 MeV,

⁸Be→2α+0.092218 MeV, T/2=0.07 fs;

the generated neutrons are radiated into a fusion target nucleus region and conduct a fusion reaction with the target nucleus.

When the neutron source adopts the gamma photoneutron source, the neutron-rich nuclei are irradiated with gamma laser or gamma rays by the gamma photoneutron source to produce single energy neutrons. Multiple options exist for the used neutron-rich nucleus, wherein two neutron-rich nuclei are deuterium nucleus d and beryllium nucleus ⁹Be; gamma photons having the energy relative to the stationary deuterium nucleus greater than the binding energy 2.224 MeV of the deuterium nucleus collide with the deuterium bare nucleus to generate the following reaction

γ+d→p+n−2.224 MeV,

the electrons having the energy relative to the stationary beryllium nucleus ⁹Be greater than the binding energy 1.665 MeV of the beryllium nucleus ⁹Be collide with the ⁹Be nucleus to generate the following reaction

γ+⁹Be→⁸Be+n−1.665 MeV;

many ways can be used to dissociate atoms into bare nuclei and electrons; one way is to irradiate the target atoms with laser or rays with single-photon energy greater than the binding energy of electrons and nuclei to dissociate the target nuclei and the electrons; the bare nuclei are separated by an electric field and, a magnetic field, modulated into single-energy bare nucleus beams and conveyed to the collision region; unionized and incompletely ionized particles continue to be irradiated and dissociated by light of the same frequency;

another realization mode of the gamma photoneutron source is: the target atoms are directly irradiated with gamma laser or gamma rays, having single-photon energy relative to the target nucleus greater than the binding energy of the target nucleus and the electrons, to dissociate the target nucleus into neutrons and other sub-nuclei; other sub-nuclei are separated for standby by the electric field and the magnetic field; and the neutrons are radiated to the target nucleus which conducts fusion with the neutrons to conduct a fusion reaction with the target nucleus.

In another embodiment, when the neutrons are generated by the deuterium nucleus, the same number of protons are produced while generating the neutrons; when the protons and the electrons are combined into hydrogen atoms, photons with energy greater than 13.6 eV are emitted; the photons are used to irradiate the helium atoms; the deuterium atoms are dissociated into the deuterium nuclei and electrons; the electric field and the magnetic field are used to separate the deuterium nuclei from the electrons for standby; heat energy is also generated in the process of generating gamma light; the heat energy is generated in the process of irradiation of the deuterium nuclei with the gamma light to dissociate the deuterium nuclei into the protons and the neutrons and in the process of absorbing the neutrons by the shielding layer 4; all the heat energy is transmitted by the energy transmission system and is used.

When the neutron source adopts the spontaneous radiation neutron source, the atomic nucleus of the spontaneous radiation neutron source is unstable; one of decay products is a neutron; the energy and the quantity of the radiated neutrons are determined by the decaying atomic nucleus; and the energy of the radiated neutrons is matched with the energy required for fusion. One of the spontaneous radiation neutron sources is ²⁵²Cf, and a half-life is T/2=2.645a; a neutron yield is 2.31×10¹² s⁻¹ g⁻¹; spectral energy distribution is maxwellian distribution, N(E)=C\sqrt{E} exp(−E/E_{T}); C is a normalization constant, E_{T}=(1.453±0.017)MeV, wherein part of neutrons can conduct fusion with the target nuclei ⁶Li and ⁹Be.

After deuterium atoms are ionized, firstly, electrons are separated from ions by an electric field. Then, the electrons and the ions are classified by speeds through a magnetic field. Charged particles of different speeds are accelerated by different electric fields, so that the speeds of the electron beam and the deuterium nucleus beam, are respectively 0.98245c and −0.00143c. The electron beam and the deuterium nucleus beam are inputted into a collision region 1 of electrons and neutron-rich bare nuclei in anti-parallel directions. At this time, in a laboratory system, the total momentum of the system is zero. In a deuterium nucleus stationary system, the speed and the energy of the electrons are respectively 0.98245c and (2.224+0.51)MeV. In the deuterium nucleus stationary system, the number density of the electrons and the deuterium nuclei is 10²⁰/cm³. The length of the collision region is 100 cm. The target atoms are ⁶Li, and the number density is 2.67×10¹⁹/cm³. The collision region is cylindrical, and has a length of 1000 cm and an inside radius of 3 cm. A target atom region 2 has an inside radius of 3.1 cm and an outside radius of 44.1 cm. The shielding layer 4 is a lead plate and has a thickness of 1 cm. The target atoms in the target atom region 2 are flowing. The target atoms flow through a magnetic field region with magnetic field strength of 3 T in a direction perpendicular to flow velocity at a speed of 30 m/s to produce an electromotive force. The electrons and the ions are combined to become high-temperature gas, and heat energy can be used. The unionized atoms are mixed with other deuterium atoms and inputted into the target atom region 2 again.

The overall process of the nuclear fusion of the present invention can be realized at low temperature, is easy to control, has no problem with Lawson conditions, and produces no radioactive spent nuclear fuel. The heat energy that is generated in the process of generating the neutrons can be effectively used. No proton polymerization occurs in the overall process and electrostatic repulsive potential energy between protons is not required to be overcome, thereby ensuring that the output energy in the overall process of the nuclear fusion is larger than input energy.

Each embodiment in the description is described in a progressive way. The difference of each embodiment from each other is the focus of explanation. The same and similar parts among all of the embodiments can be referred to each other. For the device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A low temperature controllable nuclear fusion device comprising a neutron source, an energy transmission system and a shielding layer, wherein neutrons radiated by the neutron source arc used to irradiate the target nucleus-containing substance; the energy of the neutrons is adjusted according to a selected target nucleus; the target nucleus of the neutron absorption is fissioned into a plurality of sub-nuclei; at the same time, energy is released; the released energy is transmitted by the energy transmission system; the residual neutrons not absorbed by the target nucleus are completely absorbed by the shielding layer; and the sub-nuclei and electrons produced by fission are finally combined into atoms and energy is released.

2. The low temperature controllable nuclear fusion device according to claim 1, further comprising a target nucleus-containing substance conveying system which keeps the target nucleus-containing substance in updating the flow; the target nucleus after neutron absorption are fissioned into a plurality of sub-nuclei; due to thermal motion and interaction, the target nucleus-containing substance becomes a plasma composed of positive and negative ions, electrons and unionized atoms; in addition to directly utilizing the heat energy of the plasma, the energy of the plasma is also used through a magnetohydrodynamic power generation technology; the plasma flows through a strong magnetic field with strength greater than 1 Tesla at high speed; positive and negative charged particles move in opposite directions to form positive and negative electrodes to generate electromotive force; and neutral target nucleus particles and other target nucleus-containing substance are conveyed back to a neutron radiation region.

3. A realization method of low temperature controllable nuclear fusion, wherein the method is realized based on the above nuclear fusion device; neutrons radiated by the neutron source are used to irradiate the target nucleus-containing substance; the energy of the neutrons is adjusted according to a selected target nucleus; the target nucleus of the neutron absorption is fissioned into a plurality of sub-nuclei; at the same time, energy is released; the released energy is transmitted by the energy transmission system; the residual neutrons not absorbed by the target nucleus are completely absorbed by the shielding layer; and the sub-nuclei and electrons produced by fission are finally combined into atoms and energy is released.

4. The realization method of low temperature controllable nuclear fusion according to claim 3, wherein the neutron source adopts an electron neutron source, a gamma photoneutron source, a spallation neutron source, a reactor neutron source or a spontaneous radiation neutron source.

5. The realization method of low temperature controllable nuclear fusion according to claim 4, wherein when the neutron source adopts the electron neutron source, in a vacuum chamber, a neutron-rich nucleus is dissociated into electrons and bare nuclei; the electrons and the bare nuclei are separated by an electric field and a magnetic field, and are respectively modulated into single-energy electron beams and ion beams; the single-energy electron beams and the single-energy ion beams are respectively conveyed to a collision region by the magnetic field perpendicular to an electron and ion conveying pipeline; a strong magnetic field having an intensity more than 1 T and, parallel to the electron beams and the bare nuclei is arranged in the collision region; the electron beams and the ion beams of the bare nuclei conduct anti-parallel motion and collision; the kinetic energy of the electrons relative to the bare nuclei is greater than the binding energy of the last neutron of the bare nuclei; due to the electromagnetic and weak effects of quarks in the electrons and the nuclei, the naked nuclei are fragmented into a plurality of sub-nuclei after collision, and the neutron is one of the sub-nuclei; the generated neutrons are radiated into a fusion target nucleus region and conduct a fusion reaction with the target nucleus.

6. The realization method of low temperature controllable nuclear fusion according to claim 4, wherein when the neutron source adopts the gamma, photoneutron source, the target atoms are directly irradiated with gamma laser or gamma rays having single-photon energy relative to the target nucleus greater than the binding energy of the target nucleus and the electrons, to dissociate the target nucleus into neutrons and other sub-nuclei; other sub-nuclei are separated for standby by the electric field and the magnetic field; and the neutrons are radiated to the target nucleus which conducts fusion with the neutrons to conduct a fusion reaction with the target nucleus, wherein the neutron-rich nuclei are irradiated with gamma laser or gamma rays by the gamma photoneutron source to produce single energy neutrons.

7. The realization method of low temperature controllable nuclear fusion according to claim 6, wherein when the neutron-rich nuclei adopt deuterium nuclei, the same number of protons are produced while generating the neutrons; when the protons and the electrons are combined into hydrogen atoms, photons with energy greater than 13.6 eV are emitted; the photons are used to irradiate the helium atoms; the deuterium atoms are dissociated into the deuterium nuclei and electrons; the electric field and the magnetic field are used to separate the deuterium nuclei from the electrons for standby;
heat energy is also generated in the process of generating gamma light; the heat energy is generated in the process of irradiation of the deuterium nuclei with the gamma light to dissociate the deuterium nuclei into the protons and the neutrons and in the process of absorbing the neutrons by the shielding layer; and all the heat energy is transmitted by the energy transmission system and is used.

8. The realization method of low temperature controllable nuclear fusion according to claim 4, wherein when the neutron source adopts the spontaneous radiation neutron source, the atomic nucleus of the spontaneous radiation neutron source is unstable; one of decay products is a neutron; the energy and the quantity of the radiated neutrons are determined by the decaying atomic nucleus; and the energy of the radiated neutrons is matched with the energy required for fusion, wherein part of the neutrons conduct a fusion reaction with the target nucleus.
